(19) United States
(12) Patent Application Publication
(10) Pub. No.: US 2006/0278178 A1
(43) Pub. Date: Dec. 14, 2006

(54) Bone tie

(76) Inventor: Kelly Marie Morrison-Gale, Strongsville, OH (US)

Correspondence Address: Kelly M. Morrison-Gale, 19416 Ridgeline Court, Strongsville, OH, 44136, US

(21) Appl. No.: 11/149,576

(22) Filed: Jun. 10, 2005

(51) Int. Cl. A62B 35/00

(52) U.S. Cl. 119/858

(57) ABSTRACT

A neckwear item containing a main body and bone tie structure with the flexibility of being worn together or separately. The main body portion may be worn about the neck, as decorative neckwear, or the main body portion may be slipped over a pet's collar, crating a decorative collar cover. The bone tie structure may be affixed about the main body section, as it is worn about the neck or as a collar cover, over a pet's collar, or the bone tie structure may be affixed directly to a pet's collar. The Bone Tie is created to be flexible in nature of its wear, as well as to be durable and utilitarian in its use. The main body section, when it is affixed to a pet's collar, is designed to allow for unencumbered leash attachment to a conventional pet collar, thus not interfering with the utilitarian nature of the pet's collar and/or the pet's leash.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Not Applicable

### BACKGROUND OF INVENTION

1. Field of the Invention

The present invention described herein is a continuation of Provisional Application No. 60/578,156 filed Jun. 9, 2004.

The present invention relates to an article of apparel known as a bow tie. More specifically, the present invention relates to a Bone Tie, which is more appropriately worn by pets, but not limited to pets in its use. The Bone Tie is designed to be flexible in its nature when worn by an intended pet user. The flexible design allows for the Bone Tie to be worn about the neck or to be slipped over the pet's collar. This flexibility is furthered by the ability of the user to remove the bone portion of the Bone Tie from the main body portion, which allows for the invention to be worn as a collar cover. The bone portion of the invention may also be worn independently over a pet's collar.

The present invention is not only versatile in nature, in term of its wear-ability and use, it is also embodies a ‘no-tie’ capability that is straight forward, timesaving, and does not require nimbleness, advanced coordination, or dexterity of the wearer. The present invention requires minimal effort to assemble, yet retains the frontal attics of bow tie, with the intended whimsy of a bone replacing the traditional look of a bow.

2. Description of Known Information

Bow ties are not new in invention. Bow ties intended for wear by a pet are also not new inventions. For example, U.S. Pat. No. 5,794,572 to Saunders et al. discloses a Pet Bow Tie and Method of Manufacture. However, the tubular nature of the prior art bow tie itself is not in keeping with the traditional ascetics of a bow tie. The bow tie described in the aforementioned patent also does not comprise the flexible nature of the present invention. Other differences are noted in the construction of the article. The aforementioned bow tie does not embody an easy slip on the collar design; whereas, the present invention allows for a lining in the collar cover portion of the Bone Tie. The design allows for an outwardly facing section of the main body to be made of any textile, and also allows for a lining to be added to the inner portion of the main body and for the lining to be made of a friction resistant material. The design of the aforementioned invention's collar cover does not allow for the fastening portion to provide unencumbered leash attachment.

Others have also created pet collars that are intended for ornamentation or decoration. For example, U.S. Pat. No. 6,325,024 to Masukawa discloses a collar for pet in which a traditional pet collar is permanently embellished with a collar similar to that of a human shirt collar. The aforementioned invention is intended for decorative purposed only and does not suggest that this collar be used for purposes of walking a pet or for affixing a restraining device to the pet via the invention. In contrast, the present invention allows for the decorative nature of the collar to be appreciated while allowing for a utilitarian leash to be used to properly restrain a pet at times such as during walks.

Other ornamental pet collar covers such as U.S. Pat. No. 5,878,698 to Lyell have been created for decorative purposes to conceal a pet collar as well as to provide decoration for a particular celebration or holiday. The aforementioned invention is secured to a pet collar via fasteners along the longitudinal lines of the collar-covering portion of the invention, thereby creating a scrunch affect to the collar cover material. The aforementioned invention also embodies separate decorative attachments to be secured to the midpoint of the collar cover section via a fastener on the collar cover affixing to a fastener on the decorative embellishment portion of the invention. The aforementioned invention further embodies a separate strap that may be attached to the decorative embellished portion of the invention to assure stability to the desired perpendicular positioning of the embellishment. The present invention allows for the pet's collar to be slipped through the ends of the col lar cover rather than wrapped around the pet's collar. Through its' design, the present invention allows for a smooth ascetic to its collar cover, rather than a scrunch affect. Furthermore, the present invention has an integrated means of securing about the pet's collar or collar cover and does not rely on the collar cover for its attachment or a separate strap to ensure the embellishment's stability. Therefore, the present invention is straight forward, more flexible, and less cumbersome than the aforementioned invention as described and explained in these particular detailed characteristics.

### BRIEF SUMMARY OF THE INVENTION

The Bone Tie is intended for a pet to wear about the neck. However, the invention is not limited to a pet's wearing of the bone tie; a human may also wear the invention described herein.

The present invention is comprised of a collar cover or main body portion and a bone tie structure. The collar cover or main body and bone tie structure are created in the similar manner and by a similar manufacturing method, thereby offering a streamlined, rationalized, and economical manufacturing process.

The main body, optional collar cover portion of the Bone Tie is comprised of four material sections. Three material sections are designed (but are not limited) to be comprised of similar, if not the same material. These three sections comprise the outwardly facing main body, or collar cover, portion itself, along with the two portions that are used to fasten the main body collar cover about the neck. The fourth material section is intended (but not limited) to be made of a smooth material that poses less friction when the main body portion as it is slid over a pet's collar. This material section forms the inner portion of the main body collar cover.

The bone tie structure of the present invention is comprised of at least 3 material pieces that create two main sections of the Bone Tie. The first two material sections are bone-like shaped in their appearance. These two sections are fused together. When these bone-like shaped material pieces are fused together at least one layer of stabilizing material may be present in order to reinforce the structure's shape during wear. The third material portion of the bone tie portion of the invention is used to create the means by which the bone tie may be attached to the main body or collar cover portion of the invention, or so that the bone tie may be attached directly to a pet's collar.

The present invention affords the user a flexible, whimsical means of embellishing a neck of a pet or a human. The invention may be worn simply about the neck by fastening the main body section together and adding the bone tie structure embellishment to create a whimsically inspired bow tie effect with the added twist of a bone tie. This whimsy is further enhanced when a canine wears the neckwear. The present invention accommodates other uses, as each portion may be used alone. When the main body of the invention is worn without the bone portion, it becomes a pet's collar cover. The invention's bone tie portion is further accommodating in that the bone tie portion may also be worn independent of the main body or collar cover portion of the invention, and directly attached to a pet's collar as a simple embellishment or adornment to the collar.

Prior art bow tie pet embellishments do not accommodate the inventions to be worn independent of one another. Prior art collar cover pet embellishments do not reflect the nature of the present invention wherein the present invention is designed to be whimsical, yet reflective of a humanly worn bow tie.

It is an object of the present invention to provide a flexible neck embellishment for pets.

It is an object of the present invention to provide a neckwear item for a pet that is reminiscent of a traditional bow tie, yet whimsical in nature.

It is an object of the present invention to provide a neckwear item that pets as well as humans may wear.

It is an object of the present invention to provide a simplistic mans of accommodating a sophisticated, yet whimsical neckwear item that may be easily manipulated for use and wear.

It is an object of the present invention to provide a whimsically inspired Bone Tie that is reflective of a traditional bow tie in appearance, while allowing for the near to be worn over a conventional pet collar.

It is an object of the invention to allow for the ability for the neckwear item to enhance and not hinder the utility of a traditional pet collar and leash system.

### BRIEF DESCRIPTION OF THE SEVERAL VIEWS OF THE DRAWING

FIG. 1 is a front view of the Bone Tie's main body fastener ends during assembly; depicting two lengths of material pieces, one material piece longer than the second material piece. The respective material pieces resembling a rectangular shape are folded in half, lengthwise and secured by stitching on the long edge, opposite the fold, and on one short edge.

FIG. 2 is a front view of the assembled main body fastener sections; depicting the placement of the male removal and attachment mechanism on the newly created face 1 of the male main body fastener section and the female removal and attachment mechanism; depicting its placement on face 2 of the female main body fastener section.

FIG. 3 is a front view of the main body portion of the Bone Tie. This illustration depicts the placement and attachment of the two main body-fastening sections to the main body structure. Each face 1 side of the fastener sections are affixed to the main body portion face 1 side up and face 2 side together with the right side of the main body fabric section.

FIG. 4 is a front view of the main body portion of the Bone Tie after assembly of the fastener sections to the main body material section. The main body lining section of the main body or collar cover portion of the Bone Tie is affixed to the main body material portion by placing the respective lining and material sections with the right sides of each textile together and stitching around the rectangular like shape of the main body or collar cover section of the Bone Tie. The stitches are created in such a manner so as to leave spacing for the main body section to be turned right side facing out.

FIG. 5 is a perspective view of the Bone Tie's main body or collar cover portion with the male and female fastener portions affixed, depicting the lining section enclosed within the main body's material section.

FIG. 6 is a front view of the bone tie structure, depicting the bone-shaped nature of the structure as well as the possible attachment and or securing of a stabilizing material that may be used to reinforce the shape of the bone tie structure.

FIG. 7 is a front view of the assembly of the bone portion of the Bone Tie depicting two bone shaped material sections being secured with right sides together, leaving an opening for turning the bone shaped material sections right side out.

FIG. 8 is a front view of the bone tie portion securing mechanism as it is affixed to the bone tie portion. The front view shows the male removal attachment mechanism facing upward and the stitch lines of the female removal attachment mechanism, which is located on face 2 of the bone tie securing mechanism portion.

### REFERENCE NUMBERALS

10 main body
12 bone structure
12A bone structure face 1
12B bone structure face 2
14 main body male fastener section
14A main body male fastener section face 1
14B main body male fastener section face 2
16 main body female fastener section
16A main body female fastener section face 1
16B main body female fastener section face 2
18 main body interior or lining section
20 main body male attachment and removal mechanism
22 main body female attachment and removal mechanism
24 bone structure interfacing section
26 bone structure fastener section
26A bone structure fastener section face 1
26B bone structure fastener section face 2
28 bone fastener male attachment and removal mechanism
30 bone fastener female attachment and removal mechanism

### DETAILED DESCRIPTION OF THE INVENTION

FIG. 1 refers to the creation of the male 14 and female 16 fastener sections of the main body 10 portion of the Bone Tie. Each male and female fastener sections are made of the same or similar materials, so that the material is the same or coordinates with the materials of the main body portion 10 and the bone structure 12. Each male 14 and female 16 fastener section of the main body 10 is created by folding the rectangular section of the material in half lengthwise with right sides of the material together. The rectangular sections 14 and 16 are then stitched along the long edge of each section and along one of the short edges of each folded section 14 and 16. Each fastener section 14 and 16 is then turned right side out through the remaining short edge, or non-stitched portion.

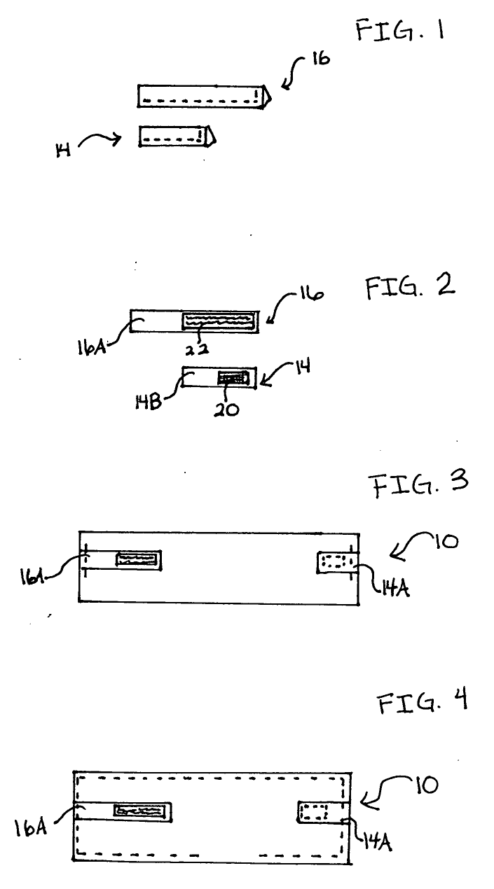

Each fastener section 14 and 16 are then ironed to ensure proper rectangular structure as well as the proper folding alignment is congruent to the newly stitched edge portion of each fastener section 14 and 16. The female fastener section 16, being longer in length than the na fastener section 14 is affixed with the female attachment and removal mechanism 22. This mechanism being of a fixed width and applied to the female fastener section 16 via stitching or any other mans appropriate to permanently affix the attachment and removal mechanism. The male fastener section 14, being shorter in length than the female fastener section 16 is affixed with the male attachment and removal mechanism 20 in the same manner as the female attachment and removal mechanism 22 is affixed to the female fastener section 16. The assembly of the male 20 and female 22 attachment and removal mechanism to the respective male 14 and female 16 fastener sections is depicted in FIG. 2.

FIG. 3 depicts the newly created male 14 and female 16 fastener section, affixed with their respective male 20 and female 22 removal and attachment mechanisms, as they are attached to the right side of the main body section 10 of the Bone Tie. The newly created female fastener section 16 is affixed to the main body section 10 with the female attachment and removal mechanism 22 facing out. The newly created male fastener 14 is affixed to the main body section 10 of with the male attachment and removal mechanism 20 facing in.

FIG. 4 depicts the lining 18 of the main body section 10 depicting the main body 10 along with the affixed fastener sections 14 and 16. The lining 18 is affixed right sides together to the main body section 10. Care is taken to ensure that the fastener sections 14 and 16 are secured within the confines of the new stitching that secures the lining section 18 to the main body section 10. A portion of the stitching that secures the main body section 10 to the lining portion 18 is left open so that the respective right sides of the main body section 10 and the lining portion 18 may be turned out. After the main body section 10 and the lining portion 18 have been turned right sides out, the right sides of the material of the main body section 10 are brought together lengthwise. The long, open end of this portion is then stitched, thereby creating a channel. The main body section 10 is then turned right side out by pulling one of the fastener ends through the channel portion.

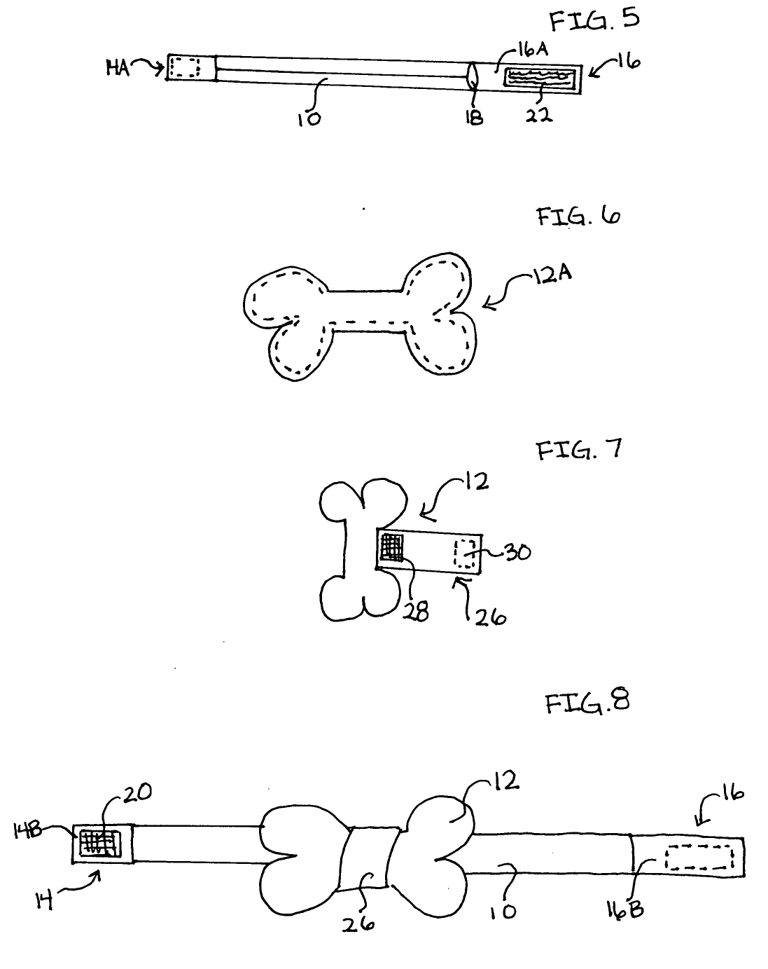

FIG. 5 depicts the finished view of the Bone Tie main body portion 10, with the interior lining portion 18 and the male fastener section 14 and the female fastener section 16. The newly created Bone Tie main body section now embodies a channel through which a pet's collar may be inserted. The male fastener section 14 and female fastener section 16 may be placed under the pet collar d-ring so that the leash may be freely attached to the pet's collar with the Bone Tie main body in place over the collar.

FIG. 6 depicts the bone portion face 1, 12A, of the bone tie structure 12 as it is affixed to the bone portion face 2, 12B. Face 1, 12A and face 2, 12B are then secured together by placing each section 12A and 12B right sides together and sewing around the outer edge of the structure. The stitching is not completed on one edge of the bone tie structure as show in the illustration to allow for the face sections 12A and 12B to be turned right sides out. None, one or both of the bone face sections 12A and 12B may have an applied interfacing section 24 so as to stabilize the bone structure 12.

FIG. 7 depicts the front view of the finished bone structure as it is affixed with the bone structure fastener section 26. The bone structure fastener section 26 is created in much the same manner as the main body male 14 and female 16 fastener sections are created. The bone structure fastener section 26 is created by folding a rectangular piece of material in half lengthwise with right sides together and then sewing the long edge and one of the short edges, leaving one short edge open for turning. Once the bone tie structure fastener section 26 is turned right side out a male attachment and removal mechanism 28 is affixed to one face 26A of the bone tie structure fastener section 26 and a female attachment and removal mechanism 30 is affixed to the other face 26B of the bone structure fastener section 26.

FIG. 8 depicts the front view of the completely assembled Bone Tie main body section 10 and the bone structure section 12. The Bone Tie main body section 10 may be worn about the neck with or without the bone structure 12. The Bone Tie main body section 10 may also be slipped over a pet's collar with main body nale 14 and female 16 fastener sections placed underneath the collar's d-ring, allowing for unencumbered leash attachment. The bone tie structure 12 may be also worn by itself, fastened about a pet's collar.

What I claim is:

1. A Bone Tie comprising:
a main body section and a bone tie structure section; said main body and bone tie structures resembling a traditional bow tie, with the whimsical change of the bow section of the neckwear resembling a bone instead of a bow, having a main body section with an outwardly facing material section comprised of one rectangular shaped section and having and inwardly facing material section comprised of one rectangular shaped section, said main body section comprised of said rectangular materials having one male and one female rectangular shaped fastener section, said rectangular section having an inner channel through which a pet's collar may be inserted, with said male and female fastener sections affixed about the neck to secure the main body section; and
a bone tie structure section having two face sides, each face side comprised of material sections resembling a bone shape, said bone tie structure having a rectangular material affixed to the shank portion of the bone shape with a male removal and attachment section affixed to one side of said rectangular material and having a female removal and attachment section affixed to the other side of said rectangular material as a mans for removing and attaching said bone tie structure about a pet's collar or the Bone Tie's main body section.

2. The bone tie structure of claim 1 wherein said bone shape may be any shape desired, accommodating a rectangular material affixed to the desired shaped as a means of removeably attaching said shape to a pet's collar, the main body portion of the invention, or any other desired receiving agent.

3. The Bone Tie main body portion of claim whereas the main body portion is used as a collar cover and does not contain the wrap around bone tie structure portion of claim 1 or the wrap around desired shape structure of claim 2.
